(19) United States
(12) Patent Application Publication
(10) Pub. No.: US 2026/0230866 A1
(43) Pub. Date: Aug. 6, 2026

(54) RESTRICTION ON TOTAL INTERRUPTION FOR BWP WITHOUT RESTRICTION

(71) Applicant: APPLE INC., Cupertino, CA (US)

(72) Inventors: Qiming Li, Beijing (CN); Yang Tang, San Jose, CA (US); Dawei Zhang, Saratoga, CA (US); Jie Cui, San Jose, CA (US); Yuexia Song, Beijing (CN); Manasa Raghavan, Sunnyvale, CA (US); Xiang Chen, Campbell, CA (US)

(21) Appl. No.: 19/152,244

(22) PCT Filed: Feb. 16, 2023
(86) PCT No.: PCT/CN2023/076436

§ 371 Date: Jul. 30, 2025

(51) Int. Cl. H04W 24/08

(52) U.S. Cl. CPC H04W 24/08

(57) ABSTRACT

The present disclosure relates to restriction on total interruption for BWP without restriction and there provides a network device, comprising at least one antenna; at least one radio coupled to the at least one antenna; and a processor coupled to the at least one radio; wherein the processor is configured to: acquire an interruption configuration scheduling interruption of a wireless device, wherein the interruption is related to acquisition by the wireless devices of reference signals for a measurement operation which are not contained in an active Bandwidth Part (BWP) of the wireless device, and provide the interruption configuration to the wireless device.

### TECHNICAL FIELD

This application generally relates to wireless communication, including configuration for measurement operation in the wireless communication.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHZ. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to apparatuses, systems, and methods to provide improved interruption configuration for interruption related to measurement operation and the related measurement operation.

According to techniques described herein, a network-side device can provide an improved interruption configuration to a wireless device so that the wireless device can optimize its interruption for a specific measurement operation, particularly measurement operation in a specific layer, such as Layer-1 (L1) measurement operation. In particular, the interruption is related to acquisition by the wireless devices of reference signals for a measurement operation which are not contained in an active bandwidth part of the wireless device.

In one aspect, the present disclosure may provide a network device, comprising at least one antenna; at least one radio coupled to the at least one antenna; and a processor coupled to the at least one radio; wherein the processor is configured to, for example, particularly cause the network device to: acquire an interruption configuration scheduling interruption of a wireless device, wherein the interruption is related to acquisition by the wireless devices of reference signals for a measurement operation which are not contained in an active bandwidth part of the wireless device, and provide the interruption configuration to the wireless device.

In another aspect, the present disclosure may provide a wireless device, comprising at least one antenna; at least one radio coupled to the at least one antenna; and a processor coupled to the at least one radio, wherein the processor is configured to acquire an interruption configuration scheduling interruption of the wireless device, wherein the interruption is related to acquisition by the wireless devices of reference signals for a measurement operation which are not contained in an active Bandwidth Part (BWP) of the wireless device, and perform the interruption operation based on the interruption configuration.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

A better understanding of the present subject matter can be obtained when the following detailed description of various embodiments is considered in conjunction with the following drawings, in which:

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3A illustrate a relationship between a carrier bandwidth and bandwidth parts for a user equipment (UE) in which reference signals for measurement operations are received in a single inactive bandwidth part, according to embodiments described herein.

FIG. 3B illustrate a relationship between a carrier bandwidth and bandwidth parts for a user equipment (UE) in which reference signals for measurement operations are received in multiple inactive bandwidth parts, according to embodiments described herein.

FIG. 4 is a flowchart diagram illustrating an example method at the network device side according to some embodiments of the present disclosure.

FIG. 5 is a flowchart diagram illustrating an example method at the wireless device side according to some embodiments of the present disclosure.

FIG. 6 schematically illustrates exemplary interruption configuration according to some embodiments of the present disclosure.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

To easily identify the discussion of any particular element or act, the most significant digit or digits in a reference number refer to the figure number in which that element is first introduced.

### Terms

User Equipment (UE) (or “UE Device”)—any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless telephone system or radio system. As an example, the base station may be, for example, an eNB in a 4G communication standard, a gNB in a 5G communication standard, a remote radio head, a wireless access point, an unmanned aerial vehicle control tower, or a communication device that performs similar functions.

Network Device—any of various types of computer systems or devices that perform communications, particularly perform wireless communication with the wireless device, such as downlink communication to the wireless device related to downlink transmission. The network device can be portable (or mobile) or may be stationary or fixed at a certain location. A base station is an example of a network device.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well any of various combinations of the above.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

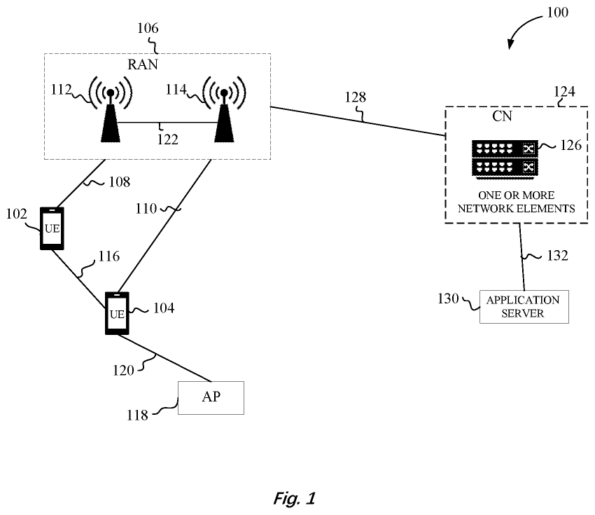

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

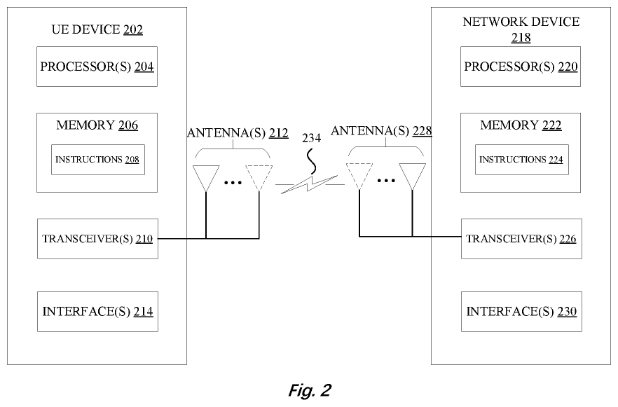

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multiuser MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may be used for various aspects of the present disclosure, particularly acquire gap configuration, particularly including gap priority information, and/or performing operation in accordance with the gap configuration, particularly based on the gap priority information. Such operation/functionality can be implemented via hardware, software, or combinations thereof. For example, such operation/functionality can be performed by means of a specific component incorporated in the wireless device, for example, a processor, circuit, which can be integrated within the processor(s) 204 and/or the transceiver(s) 210, and/or can be performed by means of software, such as instructions 208 stored in the memory 206 and executed by the processor(s) 204. In particular, such functionality can be implemented by a combination of software components (e.g., executed by a DSP or a general processor) and hardware components (e.g., logic gates and circuitry) within the processor(s) 204 or the transceiver(s) 210. Some embodiments of such operation/functionality will be described below in detail with reference to figures.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may be used for various aspects of the present disclosure, particularly acquire or configure appropriate gap configuration, particularly including gap priority information, and/or provides the gap configuration to the wireless devices so that the wireless device can perform operation in accordance with the gap configuration, particularly based on the gap priority information. Such operation/functionality can be implemented via hardware, software, or combinations thereof. For example, such operation/functionality can be performed by means a specific component incorporated in the wireless device, for example, a processor, circuit, which can be integrated within the processor(s) 220 and/or the transceiver(s) 226, and/or can be performed by means of software, such as instructions 224 stored in the memory 222 and executed by the processor(s) 220. In particular, such functionality can be implemented by a combination of software components (e.g., executed by a DSP or a general processor) and hardware components (e.g., logic gates and circuitry) within the processor(s) 220 or the transceiver(s) 226. Some embodiments of such operation/functionality will be described below in detail with reference to figures.

Wireless communication techniques are continually under development, to increase coverage, to better serve the range of demands and use cases, and for a variety of other reasons. One technique that is currently under development may relate to measurement operation by means of bandwidth part (BWP), particularly based on reference signals received in BWP.

In 5G NR, carrier bandwidth (or cell bandwidth) (CBW) is larger compared to 4G or long-term evolution (LTE). In general, the CBW may correspond to a contiguous set of physical resource blocks (PRBs), and the contiguous set of PRBs may correspond to a particular numerology of a particular carrier. A UE can be, therefore, configured to operate in a subset of the CBW to save UE power. Accordingly, the CBW may be divided into multiple BWPs. For example, the CBW may include an initial BWP, which may be used by the UE to perform an initial access process. The CBW may also include more than one BWP, which may be used by the UE for transmitting data and/or a reference signal to the base station, and/or receiving data and/or a reference signal from the base station, in a connected mode of the UE. An active BWP of the multiple BWPs of a CBW may be configured by the base station using radio resource control (RRC) signaling. Accordingly, an active BWP may be UE specific. In some embodiments, and by way of a non-limiting example, only one BWP may be an active BWP at a time. However, in some embodiments, and by way of a non-limiting example, at a time there may be two or more active BWPs.

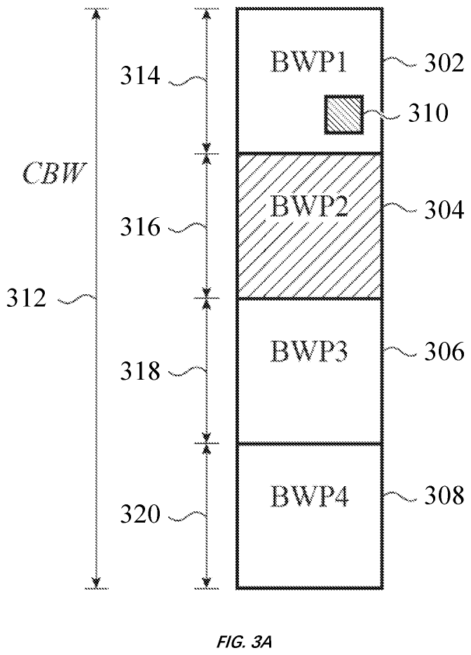

FIGS. 3A and 3B each illustrates a relationship between a carrier bandwidth and bandwidth parts for a user equipment (UE). As shown in the figures, a UE may be configured with carrier bandwidth part (CBW) 312. Such CBW 312 may be divided into multiple BWPs, so that the UE may be configured with multiple BWPs, for example, four BWPs, BWP1 302, BWP2 304, BWP3 306, and BWP4 308. By way of a non-limiting example, the BWP2 304 may be configured as an active BWP for the UE. Each BWP may have a corresponding bandwidth, and therefore, may have a corresponding number of PRBs. For example, the BWP1 302, the BWP2 304, the BWP3 306, and the BWP4 308 may have corresponding bandwidth, as shown in FIG. 3A, as 314, 316, 318, and 320, respectively. Note that the BWPs may have the same or different bandwidths. In an example, each BWP may be of the same bandwidth and thus may have the same number of PRBs included in each BWP. In another example, at least two BWP may have different bandwidths, and, therefore, may have a different number of PRBs included in the at least two BWPs.

The UE may perform one or more measurement operations, for example, for beam management (or beam level mobility), radio link failure monitoring, beam failure detection and recovery, and so on. In the present disclosure, the measurement may particularly relate to layer-1 (L1) measurement operations on layer-1 reference signals (or reference symbols) (L1-RS). In particular, such L1 measurement operations can have various types and can be performed based on various kinds of L1-RS. In an example, layer-1 measurement operations, such as beam level mobility (BM), radio link monitoring (RLM), and/or beam failure detection and recovery (BFD), will be based on a synchronization signal block (SSB) associated with an initial downlink (DL) bandwidth part (BWP), and can be configured for the initial DL BWPs and for DL BWPs containing the SSB associated with the initial DL BWP. For other DL BWPs, L1 measurement operations can only be performed based on channel state information reference signal (CSI-RS).

In some embodiments, and by way of a non-limiting example, one or more L1-RSs may have a subcarrier spacing (SCS) different from a SCS of an active BWP of a UE. A UE may be operating in a frequency range of frequency range-1 (FR1) and/or a frequency range of frequency range-2 (FR2). In other words, the CBW 312 may be FR1 or FR2.

In the present disclosure, the base station may transmit some specific signals and/or information to UE so that the UE can perform the measurement operation based on the specific signals and/or information. In some embodiments, and by way of a non-limiting example, the base station may inform the UE of a BWP in which the SSB and/or CSI-RS are transmitted to the UE for the UE to perform L1 measurement operations, such as BM, RLM, and/or BFD, and so on. For example, the base station may specify, in an RRC signaling message to the UE, an ID of a BWP in which an SSB and/or a CSI-RS are transmitted for the UE to perform L1 measurement operations. The UE would then perform one or more L1 measurement operations on the SSB and/or CSI-RS received in the BWP. The SSB and/or CSI-RS 310 on which the UE performs one or more L1 measurement operations may also be referenced herein as L1 reference signals (L1-RSs). Note that the number of BWPs containing L1-RSs may be one, for example, one BWP 1 301 contains L1-Rss 310, as shown in FIG. 3A, or be larger than one, for example, BWP 1 301, BWP 2 306, BWP3 308 contains L1-Rss 310, 310′, 310″ respectively, as shown in FIG. 3B.

Usually, such signals may be transmitted by the base station to UE within the active BWP. However, even though the CSI-RS and/or SSB for the UE to perform measurement operations are expected to be transmitted by the base station within the active BWP of the UE, there may exist a case that SSB and/or CSI-RS may be transmitted within a BWP which is not active, such as BWP1 302, which is not an active BWP for the UE, and how to support the measurement operations such as RLM, BFD, BM in such a case shall be studied.

In the present disclosure, it may perform the L1-measurement operation, such as BM/RLM/BFD, with interruption allowed in such a case. For example, when perform BM/RLM/BFD based on SSB outside active BWP, such as in an inactive BWP, the UE may receive such SSB in the non-active BWP by means of interruption, and perform the L1-measurement operation based thereon. However, when L1-RS periodicity is quite short, UE may cause too much interruption. For example, if SSB with 5 ms periodicity is configured as RLM-RS, UE would cause 1 ms interruption out of 5 ms window. Too much interruption may deteriorate the performance of the UE operation, even the user's experience. For example, even if such kind of interruption may be available for some business, some business cannot be subject to too much interruption, and would be subject to performance degradation. Therefore, in the present disclosure, an improved configuration for interruption is proposed.

Hereinafter some embodiments will be described with reference to figures. Various embodiments in the present disclosure describe how a UE may perform L1 measurement operations using reference signals that are not received or contained within an active BWP. Reference will now be made in detail to representative embodiments/aspects illustrated in the accompanying drawings. Wherein, the description may be mainly based on a specific type of operation, such as L1-layer measurement operation, however, the description and thereby the concept of the present disclosure can be equivalent to any other appropriate type of operation, particularly an operation in which the base signals or reference signals for the operation have short periodicity. The following description is not intended to limit the embodiments to one preferred embodiment. On the contrary, it is intended to cover alternatives, combinations, modifications, and equivalents as can be included within the spirit and scope of the described embodiments as defined by the appended claims.

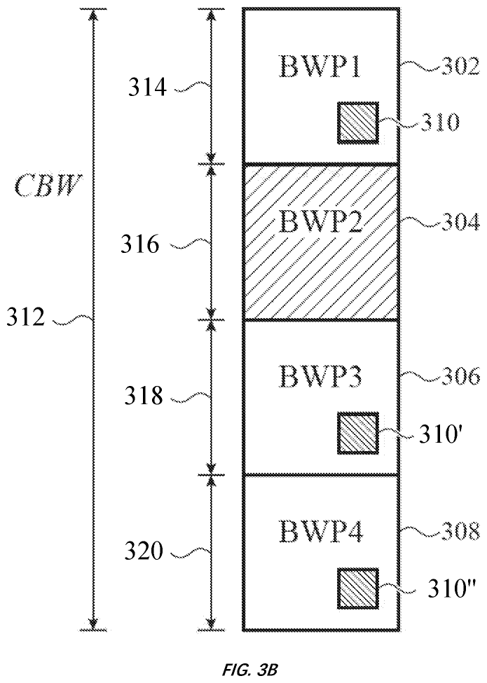

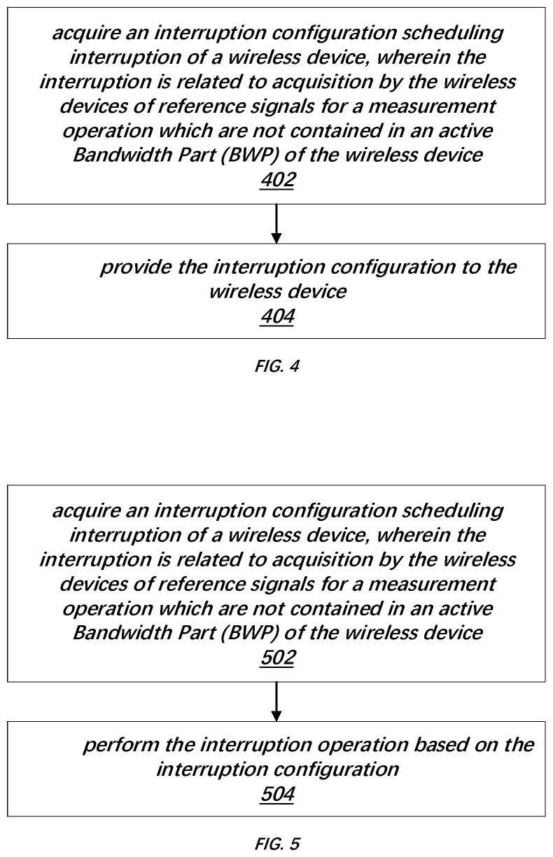

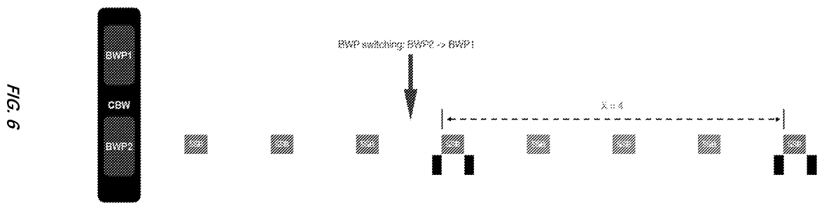

FIGS. 4 and 5 are flowchart of methods at the network device side and at the wireless device side respectively and FIG. 6 illustrates further aspects that might be used in conjunction with the method of FIGS. 4 and 5 if desired. It should be noted, however, that the exemplary details illustrated in and described with respect to FIGS. 4-6 are not intended to be limiting to the disclosure as a whole: numerous variations and alternatives to the details provided herein below are possible and should be considered within the scope of the disclosure.

FIG. 4 illustrates a flowchart illustrating an example method at the network device side at least according to some embodiments. Aspects of the method of FIG. 4 may be implemented by a network device such as a RAN 106 or CN 124 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 4 may operate as follows.

At step 402, acquire an interruption configuration scheduling interruption of a wireless device, wherein the interruption is related to acquisition by the wireless devices of reference signals for a measurement operation which are not contained in an active bandwidth part of the wireless device.

At step 404, provide the interruption configuration to the wireless device.

In an embodiment, the operations performed by the wireless device may include various measurement operations based on specific base signals or reference signals. In accordance with an embodiment, the measurement operations performed by the wireless device in BWP may relate to L1-layer measurement operation to be performed by the wireless device based on L1-layer reference signals (L1-RS). As described herein, and in accordance with some embodiments, the L1 measurement operations may include one or more of a measurement for beam level mobility (BM), a measurement for radio link monitoring (RLM), and/or a measurement for beam failure detection and recovery (BFD), and so on. In accordance with some embodiments, such L1-layer reference signals may include at least one of CSI-RS or SSB, as described above.

In accordance with an embodiment of the present disclosure, when the reference signals are not contained in the active BWP, such as contained in an inactive BWP different from or outside of the active BWP, the UE may perform some operations to receive such reference signals and some interruptions may occur accordingly along with such operations. That is, the interruptions are somewhat associated with such operations.

In accordance with an embodiment of the present disclosure, the UE may perform modification of active Bandwidth Part (BWP), and thereby the interruption may be caused, for example, the interruption is executed for implementing the modification of active BWP, so that UE can receive and use the L1-RS for measurement operation in the inactive BWP. In an embodiment, modification of the active BWP may include enlarging active bandwidth to cover or contain the L1-RS, wherein the active bandwidth may be or include the active BWP, so that the measurement operation can be performed based on the L1-RS, while such enlarging operation may cause some interruptions.

Additionally, or alternatively, in some embodiments, and by way of a non-limiting example, the UE may use an additional radio frequency (RF) chain in its baseband processing circuitry to perform L1 measurement operations on L1-RSs, which are received in a BWP that is not an active BWP configured for the UE. Generally, an RF chain may be configured to operate within an actual BW of the UE that is the same as the bandwidth of an active BWP. However, when L1-RSs are scheduled by a base station to be transmitted to a UE in an inactive BWP, the UE may use an additional RF chain to receive and perform L1 measurement operations in a BWP in which the L1-RSs are received. For power saving, UE may only switch on the additional RF on the L1-RSs occasions. The additional RF chain may share some components with other RF chain(s) on a radio frequency integrated circuit (RFIC). Switching on/off the additional RF chain may cause short interruption to other RF chain(s). Accordingly, UE may be allowed to cause interruption on other serving cells so as to receive such L1-RSs.

In accordance with the embodiments of the present disclosure, the interruption configuration may include any appropriate information about the interruption characteristic. In particular, the interruption characteristic may include, not limited to, at least one of interruption interval, interruption location, interruption length, and so on.

In an embodiment, the interruption configuration may include information about the interruption interval, that is, at what intervals the interruption is performed, such information about the interruption interval can include size of the interruption interval, also can be referred to as interruption periodicity. The size of the interruption interval can be indicated in a variety of manners, for example, may be indicated by various values. In an example, the size of the interruption interval may be configured based on characteristic of the reference signals, such as periodicity, and additionally or alternatively, may be configured as some specific values. That will be described hereinafter.

In accordance with embodiments of the present disclosure, the interruption configuration may additionally include interruption location and/or interruption size, which can be configured in various appropriate manners. In an embodiment, the interruption location may be configured related to the locations of reference signals, for example, the interruption location may be before and/or after the L1-RS. In an example, the interruption is allowed at the beginning and/or end of the L1-RS, that is, the interruption location may correspond to the beginning and/or end of the L1-RS. In another example, NW can indicate the time offset (#of SFN and slot) of interruption location with respect to RRC configuration, such as the beginning and/or end of the L1-RS. In another embodiment, the interruption length may be indicated in various manner and can be any appropriate value, which will be described in detail hereinafter.

In an embodiment, by means of the interruption location, together with the information about the interruption interval as mentioned above, both NW and UE know when interruption will occur. And the interruption can further be appropriately performed in an interruption length. Note that the interruption location and interruption length can be predefined and notified to the wireless device in advance, such as during initialization of the wireless communication, so that such interruption location and interruption length may not be included in the interruption configuration, and in such a case, the wireless device, upon receipt of the interruption configuration, can perform the interruption operation based on the interruption interval included in the interruption configuration, along with the predefined interruption location and interruption length. The same also applies to a case that any two of the interruption level, interruption location and interruption length are predefined and notified to the wireless device in advance.

In accordance with an embodiment of the present disclosure, the interruption configuration can be set in consideration of relevant characteristic of the wireless device, wherein the relevant characteristic of the wireless device includes at least one of the characteristics of the measurement operation to performed by the wireless device, the characteristic of the traction executed by the wireless device, the status of the wireless device, and so on. In an embodiment, the interruption configuration can be appropriately set in consideration of types of operations to be performed by the wireless device, particularly the measurement operation or transaction operation to be performed by the wireless device.

In an embodiment, the characteristic of the measurement operation to performed by the wireless device may include the type of the measurement operation to performed by the wireless device, such as RLM, CFD, RM, and so on, as mentioned above. The characteristic of the measurement operation can be indicated in any appropriate manner. For example, a measurement operation ID may indicate the characteristic of the measurement operation, such as the type of the measurement operation, and thus can be utilized to configure the interruption configuration.

In an embodiment, the characteristic of the traction executed by the wireless device may indicate the type, interruption tolerance and so on of the traction executed by the wireless device, particularly being currently executed by the wireless device. The characteristic of the traction can be indicated in any appropriate manner. For example, a traction ID may indicate the characteristic of the traction, such as the type, interruption tolerance and so on of the traction, and thus can be utilized to configure the interruption configuration.

In an embodiment, the status of the wireless device may indicate various states or conditions of the wireless device, such as the mobility, the location with respect to the base station or cell boundary, and so on of the wireless device. The status of the wireless device can be indicated in any appropriate manner. For example, the status of the wireless device can include at least one information items corresponding to respective states or conditions, which can be a state value, or a binary value indicating whether the state value is higher or lower than a predefined threshold.

In accordance with an embodiment of the present disclosure, the interruption configuration can be appropriately configured or set for the wireless device. In an embodiment, the interruption configuration is set or configured so that the interruption operation may be appropriately performed without obviously deteriorating the performance of the wireless device. In an embodiment, different interruption configurations can be set for different types of operation. For example, for different L1 measurement operation based on different L1-RS, different interruption configuration may be configured respectively.

In accordance with embodiments of the present disclosure, such interruption configuration can be configured statically, that is, the interruption configuration is unchanged for a wireless device during operation. In accordance with embodiments of the present disclosure, such interruption configuration can be configured dynamically, that is, perform dynamic setting of the interruption configuration based on relevant characteristic of the wireless device periodically or upon request.

In accordance with embodiments of the present disclosure, such interruption configuration can be selected from a preconfigured set of candidate interruption configurations which may be configured in advance and in consideration of a variety of factors, such as based on the relevant characteristic of the wireless device, and such interruption configuration can be selected statically or dynamically, similar with that discussed above.

In accordance with embodiments of the present disclosure, such interruption configuration may also be preconfigured in a fixed value, such as without consideration the relevant characteristics of the wireless device.

In accordance with an embodiment of the present disclosure, the interruption configuration can be set or configured at the network side and presented to the wireless device side. In an embodiment, the network side device, particularly the processor of the network side device, can be configured to acquire information about the relevant characteristic of the wireless device, and select an interruption configuration corresponding to the relevant characteristic of the wireless device for providing to the wireless device. The relevant characteristic of the wireless device can be obtained in various manners known in the art, for example, can be acquired by the network device via corresponding operation, can be acquired by the wireless device and reported to the network device, can be acquired by any other appropriate device in the network and reported to the network device, etc., and will not be described in detail herein.

In accordance with embodiments of the present disclosure, such interruption configuration can additionally be configured further based on information about interruption from the wireless device. In an embodiment, the network device, particularly its processor, is configured to: receive a suggested interruption configuration from a wireless device, judge whether the suggested interruption configuration is appropriate or not, and based on the judgement, provide a specific interruption configuration to the wireless device.

More specifically, the UE can estimate or determine its corresponding interruption configuration based on its relevant characteristic, as described above, and report its estimated interruption configuration as a suggested interruption configuration to the network device. In an example, such correspondence between the interruption configuration and characteristic of the wireless device can be preconfigured and stored in advance, and when the relevant characteristic of the wireless device may change, the wireless device can retrieve the stored correspondence, find the corresponding interruption configuration, and report it to the network device.

On the other hand, the network device can receive the suggested interruption configuration and judge the relevant characteristic of the wireless device corresponding to the suggested interruption matches the characteristic acquired by the network device per se, and if no, the network device may determine an interruption configuration more suitable for the characteristic acquired by the network device per se. For example, when the estimated interruption configuration from the UE reflects the UE can subject more frequent interruption while the network device can determine the interruption can be less frequent, the network device can transmit the less-frequent interruption configuration to the wireless device, so that the wireless device can reduce its interruption and the overhand can be further reduced.

Thus, the method of FIG. 4 may be used by a network device to set and provide improved interruption configuration so that the wireless device can perform improved interruption operations, at least according to some embodiments.

FIG. 5 illustrates a flowchart illustrating an example method at the wireless device side at least according to some embodiments. Aspects of the method of FIG. 5 may be implemented by a terminal-side device for example a UE 102, 104 illustrated in various of the Figures herein, and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements. In various embodiments, some of the elements of the methods shown may be performed concurrently, in a different order than shown, may be substituted for by other method elements, or may be omitted. Additional elements may also be performed as desired.

As shown, the method of FIG. 5 may operate as follows.

At step 502, acquire an interruption configuration scheduling interruption of the wireless device, wherein the interruption is related to acquisition by the wireless devices of reference signals for a measurement operation which are not contained in an active Bandwidth Part (BWP) of the wireless device.

At step 504, perform the interruption operation based on the interruption configuration.

In accordance with an embodiment of the present disclosure, the interruption configuration can comprise any appropriate information, such as information about at least one of interruption interval, interruption location, interruption length, and so on, as described above, and will not be described again here.

In an embodiment of the present disclosure, the wireless device, particularly, the processor included in or associated with the wireless device, can be further configured to perform the interruption operation based on the information contained in the configuration, particularly at the interruption interval indicated in the interruption configuration. More specifically, upon receipt of the interruption configuration which may include the information about size of the interruption interval, the wireless device can perform the interruption at the interruption interval, and by means of the interruption, the wireless device can acquire the reference signals, such as SSB or CSI-RS for L1 measurement operation, such as by enlarging the active bandwidth and/or activating an additional RF chain, and then perform the measurement operation based on the reference signals. Note that even at least two of the interruption interval size, interruption location, interruption length can be predefined, and the interruption can still be performed accordingly, as described above, and such case will not be described in detail here.

In accordance with an embodiment of the present disclosure, the wireless device, particularly the processor associated with or included in the wireless device, can be further configured to acquire an interruption configuration corresponding to the operation characteristic of the wireless device, and provide the acquired interruption configuration to the network device as a suggested interruption configuration. Accordingly, the network device can determine or judge the final interruption configuration based on the suggestion interruption configuration, such as based on judgement of the suggestion interruption configuration as mentioned above.

In accordance with an embodiment of the present disclosure, the wireless device, particularly the processor associated with or included in the wireless device, can be further configured to after the interruption, provide a specific operation in a BWP based on the signals included therein. For example, by means of the interruption, the wireless device can acquire the reference signals from a BWP which can contain the reference signals for operation, such as an inactive BWP contain CSI-RS or SSB for L1 measurement operation, so that the wireless device can perform the L1 measurement operation based on the received CSI-RS or SSB.

Thus, the method of FIG. 5 may be used by a wireless device or a terminal-side device, such as a UE, to perform the interruption based on the interruption configuration and related measurement operation, at least according to some embodiments.

In accordance with embodiments of the present disclosure, the interruption configuration may apply when the reference signals are not contained in an active BWP, such as an inactive BWP outside of the active BWP. In particular, even the wireless device acquires the interruption configuration, such as from the wireless device or from other appropriate device in the network, if the reference signals are transmitted while being contained in the active BWP, the wireless device will skip the interruption, that is, perform the measurement operation based on the reference signals without interruption. Otherwise, if the reference signals are transmitted while being contained in a BWP which is not the active BWP, such as an inactive BWP, the wireless device will perform the interruption so as to acquire the reference signals in such inactive BWP and perform the measurement operation based on the reference signals.

Hereinafter some exemplary embodiments according to the present disclosure will be described, where the exemplary embodiments relate to various interruption configurations. Note that the exemplary embodiments are described mainly based on interruption operation related to L1 measurement operations, but such description is not limitative, and the concept of the present disclosure can be equivalently utilized to other types of interruption.

### First Embodiment

Hereinafter, the first embodiment according to the present disclosure will be described, and in this embodiment, an improved interruption configuration can be set, or configured based on the characteristics of reference signals for operation, particularly SSB for L1 measurement operation. In particular, the interruption configuration may include information about the interruption interval, which may indicate the relationship between the size or periodicity of interruption interval and the SSB, for example the size or the periodicity of interruption interval of the interruption and the periodicity of SSB.

In accordance with the embodiment, such information about the interruption interval may include a scaling factor, that indicate how to scale the periodicity of the reference signals to configure the size of interruption interval or periodicity of interruption, and the processor is configured to perform the interruption operation based on the interruption interval determined by scaling the period of reference signals based on the scaling factor.

In an embodiment, the scaling factor can be represented in a variety of manners. In an example, the scaling factor can be any appropriate value, such as an integer X, for example, from 1 to N. N can be set empirically. And the interruption interval may correspond to X SSB, that is, the interruption may be performed every X SSBs. Note that such scaling factor may be applicable only when the reference signals are not contained in an active BWP, such as an inactive BWP outside of the active BWP.

FIG. 6 illustrates a diagram of the scaling factor according to the embodiment of the present disclosure. Among them, the base station configures a CBW for a UE, and the CBW includes two BWP, BWP 1 and BWP2. The base station may carry the measurement reference signals in the CBW, particularly in BWP. For example, the measurement reference signals may include SSBs for L1 operation, and may be carried in BWP 2.

In accordance with the embodiment of the present disclosure, the scaling factor X only applies when UE active BWP does not contain SSB. When the BWP 2 is an active BWP, X doesn't apply, and the UE can directly utilize the SSBs in BWP2 for measurement, such as L1 measurement operation. On the other hand, when the BWP 1 is an active BWP, considering the reference signals for measurement operations are carried in BWP 2 which is an inactive BWP and outside of the active BWP 1, the UE shall perform interruption by means of the scaling factor X so as to acquire SSB from BWP2 to use SSB for measurement operation. In particular, UE performs L1 measurement operation every X SSBs. For example, when the scaling factor is 4, the interruption may be performed every four SSBs.

In an embodiment, the scaling factor may be configured via RRC signaling. In an example, the network device can configure and notify the scaling factor via RRC signaling, and the UE can utilize it for the measurement operation, such as L1 measurement operation.

In according with the embodiment of the present disclosure, the scaling factor can be configured in various manners.

In an embodiment, the scaling factor may be configured for respective measurement operation, particularly L1 measurement operation. In an example, preferably, different X can be configured for different L1 operation, such as X1 for RLM, X2 for BFD and etc. Additionally, or alternatively, the scaling factor may be configured for respective terminal devices, UEs, for example, may be configured based on the type of measurement operation to be performed by the UE and the characteristic of the UE, such as operation condition or mobility, etc.

In an example, such scaling factor can be statically configured and utilized, for example, such scaling may be unchanged during operation. In another example, such scaling factor can be dynamically configured and utilized, for example, may be dynamically configured in consideration the relevant characteristics of the wireless device during operation, similar with that described above.

In an example, such scaling factor may be configured, such as during initialization of the network or during the measurement operation starts. In an example, during initialization of the network, different scaling factors may be configured for different kinds of L1 measurement operations and would be utilized during operation. In another example, when a measurement operation is intended to start, its corresponding scaling factor would be configured and utilized for such operation.

In an embodiment, a set of scaling factors can be preconfigured, such as serve as candidate scaling factors, and during usage, an appropriate scaling factor can be selected from the set of scaling factors. In an example, a set of scaling factors are preconfigured via RRC. NW can use MAC-CE to select X, for example, select appropriate scaling factor separately for different L1 measurement operations. And even for the same L1 operations, when the UE characteristic, such as operation condition or mobility of UE changes, the scaling factor can be changed for such L1 measurement operation.

In an embodiment, the scaling factor can be a specific value which is predefined in specification, e.g., X=4. In an example, in operation, the scaling factor would be utilized unchanged. Among them, different scaling factors may also be predefined in specification.

### Second Embodiment

Hereinafter, the second embodiment according to the present disclosure will be described, and in this embodiment, an improved interruption configuration can be set or configured to include information about the interruption interval, particularly information related to a minimum interruption interval and/or a maximum interruption interval, or a minimum periodicity of interruption and/or a maximum periodicity of interruption. The minimum interruption interval or minimum periodicity of the interruption may indicate the most frequent interruption the wireless device can withstand without deteriorating its performance obviously, for example, the degree of performance deterioration can be below a specific threshold. The maximum interruption interval or maximum periodicity of the interruption may indicate the sparsest interruption necessary for acquisition of reference signals, if any.

In an embodiment, such minimum interruption interval and the maximum interruption interval can be determined or configured in various manners, such as may be based on at least one of the relevant characteristic of the UE operation, the relevant characteristic of the network device operation, and so on, and may not relate to the characteristic of the reference signals. In an example, such minimum interruption interval may be configured so as to guarantee L1 operation performance while too frequent interruptions can be avoided, and can be configured or determined based on at least one of the performance of the wireless device and the measurement requirement. In another example, such maximum interruption interval can be configured so as to reduce interruption.

In an embodiment, the terminal device can perform the interruption, if any, at an appropriate interruption interval which can be set with respect to the minimum interruption interval and/or the maximum interruption interval. In particular, the appropriate interruption interval may be equal to or larger than the minimum interruption interval, and/or be equal to or smaller than the maximum interruption interval.

In accordance with embodiments of the present application, the network device, particularly the processor included in the network device, can compare the periodicity of reference signals for measurement operation and the minimum interruption interval and/or maximum interruption interval, and provide the comparison result as the information about interruption interval included in the interruption configuration to the wireless device. In an embodiment, the network device, particularly the processor included in the network device, can compare the periodicity of reference signals for measurement operation and the minimum interruption interval and, and provide the larger one of the two to the wireless device as the information related to the minimum interruption interval included in the interruption configuration. In another embodiment, the network device, particularly the processor included in the network device, can compare the periodicity of reference signals for measurement operation and the maximum interruption interval and, and provide the smaller one of the two to the wireless device as the information related to the maximum interruption interval included in the interruption configuration.

In another example, the network device, particularly the processor included in the network device, can provide the minimum interruption interval or the maximum interruption interval per se to the wireless device, and the wireless device can perform such comparison and utilize an appropriate one to perform the interruption, as described above.

For example, the minimum interruption interval Y only applies when UE active BWP does not contain SSB for L1 operation. For example, similar with that for the scaling factor X as discussed above, when a BWP containing SSB is active Y doesn't apply. UE performs L1 operation on every configured SSB. When a BWP not containing SSB is active, Y applies. UE performs L1 operation on interruption interval which is determined as the larger one of Y and periodicity of SSB.

$$Interruption interval = max ( Y , {T}_{L 1 - RS} )$$

In accordance with an embodiment of the present application, the minimum interruption can be configured in various manners, similar with that for the scaling factor as described above.

In an embodiment, the minimum interruption can be configured statically or dynamically. In an embodiment, the minimum interruption Y is configured via RRC signaling. Additionally, different Y can be configured for different L1 operation, such as Y1 for RLM, Y2 for BFD and etc. In an example, a set of minimum interruption Y is preconfigured via RRC. NW can use MAC-CE to select Y, for example, separately for different L1 measurement operations, or separately for different conditions of the same L1 operation. In yet another example, Y can be predefined in specification as a specific value, e.g., Y=20 ms.

Note that the maximum interruption interval, if any, can be set, selected or processed in a way similar with that for the minimum interruption, except that the interruption interval obtained by comparison would be the smaller one between the periodicity of the reference signals and the maximum interruption interval.

### Third Embodiment

Hereinafter, the third embodiment according to the present disclosure will be described, and in this embodiment, an improved interruption configuration can be set, or configuration based on the characteristics of reference signals for measurement operation, particularly SSB for L1 measurement operation. In particular, the interruption configuration may relate to, may include information about interruption length.

In accordance with an embodiment of the present disclosure, such information about interruption length may be indicated by an acceptable interruption ratio which may indicate what percentage of interruption with respect to whole downlink and uplink slots can be acceptable. In an example, such information may include a maximum interruption ratio that indicates the maximum acceptable percentage of interruption in whole downlink and uplink slots without deteriorating its performance obviously, for example, the degree of performance deterioration can be kept below a specific threshold. Therefore, too long interruption can be avoided. In an embodiment, the maximum interruption ratio can be equivalent to a specific interruption length which is configured so that the ratio of the specific interruption length occupied in the whole downlink and uplink slots is the maximum interruption ratio. For example, an interruption ratio Z % may mean Z % of the downlink and uplink slots can be interrupted.

In an embodiment, such maximum interruption ratio can be determined or configured based on the relevant characteristic of the UE operation. In an example, the network device can determine such minimum value based on the performance of the wireless device, and the measurement requirement.

In an embodiment, the processor is further configured to derive a corresponding interruption length from the whole downlink and uplink slots based on the maximum interruption ratio, and perform the interruption operation based on the interruption length. In an embodiment, the terminal device can perform the interruption, if any, in an interruption length equal to or smaller than interruption length determined by the maximum interruption ratio.

In accordance with an embodiment of the present disclosure, a maximum interruption ratio Z % can be configured in various manners, for example, similar with that for the scaling factor as described above. In particular, the maximum interruption ratio can be configured statically or dynamically.

In an example, Z is configured via RRC signaling. Additionally, different Z can be configured for different L1 operation, such as Z1 for RLM, Z2 for BFD and etc. In an example, a set of maximum interruption Z is preconfigured via RRC. NW can use MAC-CE to select Z, for example, separately for different L1 operations, or separately for different conditions of the same L1 operation. In yet another example, Z can be predefined in specification, e.g., Z=0.5%.

Note that the information about the interruption length, if contained in the interruption configuration, can be in any other appropriate format. In an example, information about the interruption length may directly indicate a value of the interruption length which can be appropriately determined. For example, the interruption length may depend on RF switching time, which may be pre-defined in 3GPP Technical Specifications, for example, 0.5 ms for serving cell(s) in FR1 and 0.25 ms for serving cell(s) in FR2.

Note that at least two embodiments of the above first to three embodiments can be combined so that the interruption configuration can be more appropriately set, and the wireless device can perform more appropriate interruption. For example, improved interruption interval and length can be configured for the wireless device. In particular, at least two embodiments of the above first to three embodiments can be combined with the configured interruption location.

In accordance with the embodiment of the present disclosure, by combination of the interruption interval, interruption length as mentioned in the previous embodiments, as well as the interruption location predefined in the specification or transmitted by the network device, the UE can know when interruption will occur, how frequent the interruption performs, and how long the interruption performs in a cycle.

Embodiments contemplated herein include an apparatus comprising means to perform one or more elements of the method for configuring and/or providing the interruption configuration at the network device according to embodiments of the present disclosure. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method at the network device according to embodiments of the present disclosure. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method at the network device according to embodiments of the present disclosure. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method at the network device according to embodiments of the present disclosure. This apparatus may be, for example, an apparatus of a base station (such as a network device 218 that is a base station, as described herein).

Embodiments contemplated herein include a signal as described in or related to one or more elements of the method at the network device according to embodiments of the present disclosure.

Embodiments contemplated herein include a computer program or computer program product comprising instructions, wherein execution of the program by a processing element is to cause the processing element to carry out one or more elements of the method at the network device according to embodiments of the present disclosure. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

Embodiments contemplated herein include an apparatus comprising means to perform one or more elements of the method for acquiring the interruption configuration and/or performing interruption at the wireless device side. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method at the wireless device side according to some embodiments of the present disclosure. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method at the wireless device side according to some embodiments of the present disclosure. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method at the wireless device side according to some embodiments of the present disclosure. This apparatus may be, for example, an apparatus of a UE (such as a wireless device 202 that is a UE, as described herein).

Embodiments contemplated herein include a signal as described in or related to one or more elements of the method at the wireless device side according to some embodiments of the present disclosure.

Embodiments contemplated herein include a computer program or computer program product comprising instructions, wherein execution of the program by a processor is to cause the processor to carry out one or more elements of the method at the wireless device side according to some embodiments of the present disclosure. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

In the following further exemplary embodiments are provided.

One set of embodiments may include a network device, comprising at least one antenna; at least one radio coupled to the at least one antenna; and a processor coupled to the at least one radio, wherein the processor is configured to acquire an interruption configuration scheduling interruption of a wireless device, wherein the interruption is related to acquisition by the wireless devices of reference signals for a measurement operation which are not contained in an active Bandwidth Part (BWP) of the wireless device, and provide the interruption configuration to the wireless device.

According to some embodiments, the reference signals are contained in an inactive Bandwidth Part (BWP) which is outside of the active BWP, and the acquisition of reference signals is performed by the wireless device enlarging active bandwidth or activating additional RF chain.

According to some embodiments, the reference signals include L1-layer reference signals (L1-RS), and the measurement operations performed by the wireless device based on the reference signals relate to L1-layer measurement operation to be performed by the wireless device based on L1-layer reference signals (L1-RS).

According to some embodiments, wherein the interruption configuration is set in consideration of relevant characteristic of the wireless device, and wherein the relevant characteristic of the wireless device includes at least one of the characteristics of the measurement operation to performed by the wireless device, the characteristic of the traction executed by the wireless device, the status of the wireless device.

According to some embodiments, different interruption configurations are set for different types of measurement operations to be performed by the wireless device.

According to some embodiments, the interruption configuration is statically set so that the interruption configuration is unchanged for a wireless device during operation, and/or the interruption configuration is dynamically set based on relevant characteristic of the wireless device periodically or upon request.

According to some embodiments, the processor is configured to acquire information about relevant characteristic of the wireless device, and determine an interruption configuration corresponding to the relevant characteristic of the wireless device for providing to the wireless device.

According to some embodiments, the processor is configured to select one of a preconfigured set of candidate interruption configurations based on the relevant characteristic of the wireless device.

According to some embodiments, the processor is configured to receive a suggested interruption configuration from a wireless device, judge whether the suggested interruption configuration is appropriate or not, and based on the judgement, provide a specific interruption configuration to the wireless device.

According to some embodiments, the interruption configuration includes information about interruption interval.

According to some embodiments, the information about interruption interval includes at least one of a scaling factor for scaling the period of reference signals, a minimum interruption interval acceptable at the wireless device during operation, a maximum interruption interval acceptable at the wireless device during operation, or a maximum interruption ratio acceptable at the wireless device during operation.

According to some embodiments, the processor is configured to compare a minimum interruption interval acceptable at the wireless device during operation and a periodicity of reference signals, and provide the larger one of the two to the wireless device as the interruption configuration.

According to some embodiments, the processor is configured to compare a maximum interruption interval acceptable at the wireless device during operation and a periodicity of reference signals, and provide the smaller one of the two to the wireless device as the interruption configuration.

According to some embodiments, the interruption configuration further comprises at least one of interruption location and interruption length.

Another set of embodiments may include a wireless device, comprising at least one antenna; at least one radio coupled to the at least one antenna; and a processor coupled to the at least one radio, wherein the processor is configured to acquire an interruption configuration scheduling interruption of the wireless device, wherein the interruption is related to acquisition by the wireless devices of reference signals for a measurement operation which are not contained in an active Bandwidth Part (BWP) of the wireless device, and perform the interruption operation based on the interruption configuration.

According to some embodiments, the processor is further configured to, based on the interruption configuration, perform the interruption operation to acquire the reference signals for measurement operation, for example, by enlarging the active bandwidth to cover the reference signals and/or activating an additional RF chain to receive the reference signals.

According to some embodiments, the interruption configuration includes a maximum interruption ratio acceptable at the wireless device, and wherein the processor is further configured to derive a corresponding interruption length from a whole of uplink and downlink slots based on the maximum interruption ratio, and perform the interruption operation based on the derived interruption length.

According to some embodiments, the interruption configuration includes a minimum interruption interval acceptable at the wireless device, and the processor is further configured to compare the minimum interruption interval and a periodicity of the reference signals, and utilize the larger one of the two as the interruption interval for the interruption operation.

According to some embodiments, the interruption configuration includes a maximum interruption interval acceptable at the wireless device, and the processor is configured to compare the maximum interruption interval acceptable at the wireless device during operation and a periodicity of reference signals, and provide the smaller one of the two to the wireless device as the interruption configuration.

According to some embodiments, the processor is further configured to acquire an interruption configuration set in consideration of relevant characteristic of the wireless device, and provide the acquired interruption configuration to the network device as a suggested interruption configuration.

Yet another set of embodiments may include an apparatus, comprising: a processor configured to cause a network device to acquire an interruption configuration scheduling interruption of a wireless device, wherein the interruption is related to acquisition by the wireless devices of reference signals for a measurement operation which are not contained in an active Bandwidth Part (BWP) of the wireless device, and provide the interruption configuration to the wireless device.

According to some embodiments, the processor can cause the network device to implement any or all parts of any of the preceding embodiments/examples.

Yet another set of embodiments may include an apparatus, comprising: a processor configured to cause a wireless device to acquire an interruption configuration scheduling interruption of the wireless device, wherein the interruption is related to acquisition by the wireless devices of reference signals for a measurement operation which are not contained in an active Bandwidth Part (BWP) of the wireless device, and perform the interruption operation based on the interruption configuration.

According to some embodiments, the processor can cause the wireless device to implement any or all parts of any of the preceding embodiments/examples.

Yet another set of embodiments may include a method for a network device, comprising acquiring an interruption configuration scheduling interruption of a wireless device, wherein the interruption is related to acquisition by the wireless devices of reference signals for a measurement operation which are not contained in an active Bandwidth Part (BWP) of the wireless device, and providing the interruption configuration to the wireless device.

According to some embodiments, the method can be further performed by the network device to implement any or all parts of any of the preceding embodiments/examples.

Yet another set of embodiments may include a method for a wireless device, comprising acquiring an interruption configuration scheduling interruption of the wireless device, wherein the interruption is related to acquisition by the wireless devices of reference signals for a measurement operation which are not contained in an active Bandwidth Part (BWP) of the wireless device, and performing the interruption operation based on the interruption configuration.

According to some embodiments, the method can be further performed by the wireless device to implement any or all parts of any of the preceding embodiments/examples.

Yet another set of embodiments may include a device comprising: a processor, and a computer-readable storage medium, having program instructions stored thereon, which, when executed, cause the processor to implement any or all parts of any of the preceding method embodiments.

Yet another set of embodiments may include a computer-readable storage medium, having program instructions stored thereon, which, when executed, cause the processor to perform any or all parts of any of the preceding method embodiments.

Yet another set of embodiments may include a computer program product comprising program instructions, which, when executed by a computer, cause a computer to perform any or all parts of any of the preceding method embodiments.

Yet another set of embodiments may include a computer program comprising program instructions, which, when executed by a computer, cause a computer to perform any or all parts of any of the preceding method embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above-described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A network device, comprising:
at least one antenna;
at least one radio coupled to the at least one antenna; and
a processor coupled to the at least one radio;
wherein the processor is configured to:
acquire an interruption configuration scheduling interruption of a wireless device, wherein the interruption is related to acquisition by the wireless devices of reference signals for a measurement operation which are not contained in an active Bandwidth Part (BWP) of the wireless device, and
provide the interruption configuration to the wireless device.

2. The network device of claim 1, wherein the reference signals are contained in an inactive BWP which is outside of the active BWP, and the acquisition of the reference signals is performed by the wireless device enlarging active bandwidth or activating an additional RF chain.

3. The network device of claim 1, wherein the reference signals include L1-layer reference signals (L1-RS), and the measurement operations performed by the wireless device based on the reference signals relate to L1-layer measurement operation to be performed by the wireless device based on the L1-RS.

4. The network device of claim 1, wherein the interruption configuration is set in consideration of a relevant characteristic of the wireless device, and
wherein the relevant characteristic of the wireless device includes at least one of the measurement operation to performed by the wireless device, a traction executed by the wireless device, and a status of the wireless device.

5. The network device of claim 1, wherein different interruption configurations are set for different types of measurement operations to be performed by the wireless device.

6. The network device of claim 1, wherein the interruption configuration is statically set so that the interruption configuration is unchanged for the wireless device during operation, or
the interruption configuration is dynamically set based on a relevant characteristic of the wireless device periodically or upon request.

7. The network device of claim 1, wherein the processor is configured to:
acquire information about a relevant characteristic of the wireless device, and
determine the interruption configuration corresponding to the relevant characteristic of the wireless device for providing to the wireless device.

8. The network device of claim 1, wherein the processor is configured to:
select one of a preconfigured set of candidate interruption configurations based on a relevant characteristic of the wireless device.

9. The network device of claim 1, wherein the processor is configured to:
receive a suggested interruption configuration from the wireless device,
determine a judgement whether the suggested interruption configuration is appropriate or not, and
based on the judgement, provide a specific interruption configuration to the wireless device.

10. The network device of claim 1, wherein the interruption configuration includes information about an interruption interval.

11. The network device of claim 10, wherein the information about the interruption interval includes at least one of:
a scaling factor for scaling a period of the reference signals,
a maximum interruption interval acceptable at the wireless device during operation,
a minimum interruption interval acceptable at the wireless device during operation, or
a maximum interruption ratio acceptable at the wireless device during operation.

12. The network device of claim 11, wherein the processor is configured to:
compare a minimum interruption interval acceptable at the wireless device during operation and a periodicity of the reference signals, and
provide a larger one of the minimum interruption interval and the periodicity to the wireless device as the interruption configuration.

13. The network device of claim 11, wherein the processor is configured to:
compare a maximum interruption interval acceptable at the wireless device during operation and a periodicity of the reference signals, and
provide a smaller one of the maximum interruption interval and the periodicity to the wireless device as the interruption configuration.

14. The network device of claim 1, wherein the interruption configuration further comprises at least one of an interruption location and an interruption length.

15. A wireless device, comprising:
at least one antenna;
at least one radio coupled to the at least one antenna; and
a processor coupled to the at least one radio;
wherein the processor is configured to:
acquire an interruption configuration scheduling interruption of the wireless device, wherein the interruption is related to acquisition by the wireless devices of reference signals for a measurement operation which are not contained in an active Bandwidth Part (BWP) of the wireless device, and
perform an interruption operation based on the interruption configuration.

16. The wireless device of claim 15, wherein the processor is further configured to:
based on the interruption configuration, perform the interruption operation to enlarge active bandwidth or activate an additional Radio Frequency (RF) chain to acquire the reference signals for the measurement operation.

17. The wireless device of claim 15, wherein the interruption configuration includes a maximum interruption ratio acceptable at the wireless device, and wherein the processor is further configured to:
derive a corresponding interruption length from a whole of uplink and downlink slots based on the maximum interruption ratio, and
perform the interruption operation based on the derived interruption length.

18. The wireless device of claim 15, wherein the interruption configuration includes a minimum interruption interval acceptable at the wireless device, and the processor is further configured to:
compare the minimum interruption interval and a periodicity of the reference signals, and
utilize a larger one of the minimum interruption interval and the periodicity as the interruption interval for the interruption operation.

19. The wireless device of claim 15, wherein the interruption configuration includes a maximum interruption interval acceptable at the wireless device, and the processor is further configured to:
compare the maximum interruption interval and a periodicity of the reference signals, and
utilize a smaller one of the maximum interruption interval and the periodicity as the interruption interval for the interruption operation.

20. The wireless device of claim 15, wherein the processor is further configured to:
acquire an acquired interruption configuration set in consideration of a relevant characteristic of the wireless device, and
provide the acquired interruption configuration to a network device as a suggested interruption configuration.

21-27. (canceled)
